(19) United States
(12) Patent Application Publication
(10) Pub. No.: US 2018/0132986 A1
(43) Pub. Date: May 17, 2018

(54) DENTAL PROSTHESIS WITH A MULTIPART DESIGN, AND METHOD AND DEVICE FOR PRODUCING SAME

(71) Applicant: Fraunhofer-Gesellschaft zur Foerderung der angewandten Forschunge.V., Muenchen (DE)

(72) Inventors: Herbert Wolter, Tauberbischofsheim (DE); Florian Hausler, Bielefeld (DE); Jeannette Hoffmann, Wurzburg (DE)

(73) Assignee: Fraunhofer-Gesellschaft zur Foerderung der angewandten Forschung e.V., Muenchen (DE)

(21) Appl. No.: 15/564,321

(22) PCT Filed: Apr. 8, 2016
(86) PCT No.: PCT/EP2016/057776

§ 371 Date: Oct. 4, 2017

(30) Foreign Application Priority Data
Apr. 9, 2015 (DE) 102015105424.8
Jun. 30, 2015 (DE) 102015110548.9
Aug. 4, 2015 (DE) 102015112800.4

(51) Int. Cl. A61C 13/08; A61C 13/083; A61C 13/07

(52) U.S. Cl. CPC A61C 13/081; A61C 13/09; A61C 13/0025; A61C 13/0835

(57) ABSTRACT

The invention relates to a dental prosthesis comprising a first inner sub-region which has a first organically polymerized material and a second outer sub-region, which has a second organically polymerized material that is an organically modified and organically polymerized silicic acid (hetero)polycondensate. The first inner sub-region has a flexural strength of over 80 MPa according to DIN EN ISO 4049: 2009 and a lower elastic modulus than the second outer sub-region, while the second, outer sub-region has a flexural strength of at least 100 MPa according to DIN EN ISO 4049: 2009. The first organically polymerized material is preferably also an organically modified and organically polymerized material.

The dental prosthesis can be generated preferably using a mold system consisting of at least one first and a second negative mold, and the second negative mold is shaped so as to form a second cavity, Either both negative molds consist of at least two parts or the first negative mold is a single part and has an opening for the admission of light or IR radiation.

The present invention relates to a dental prosthesis (denture or prosthetic tooth, and parts of such a prosthesis, also referred to as dental prostheses, such as e.g. onlays, veneers or crowns) with high wear resistance consisting of at least two components that differ with respect to their elastic modulus but both have excellent flexural strength, and that can be produced using a simple mold system consisting of a first and a second negative mold. Preferably, the two components also differ with regards to their translucency.

To restore the chewing function after a loss of a part or the entire dentition, a partial or full prosthesis replaces the missing teeth of a patient. Currently, prosthetic teeth are manufactured by a very labor-intensive process. Generally, the material basis for prefabricated prosthetic teeth is currently ceramic and increasingly PMMA (polymethylmethacrylate). Both materials, however, have significant disadvantages. The relevant reasons for the lower market share of ceramic teeth are the lack of chemical bonding to the prosthesis base material, high susceptibility to fracture, complex repair/rework in case of a fracture, and a high abrasion of the antagonist tooth. A further disadvantage is that with ceramic teeth biting together e.g. during eating can be heard (“clacking”), which reduces the wearing comfort. Although plastic teeth based on polymethylmethacrylate show first material improvements with respect to abrasion resistance (wear resistance), hardness, and oral durability, they still have serious shortcomings, such as strong self-abrasion due to the low mechanical parameters of PMMA and a residual monomer content that can trigger allergies.

In order to achieve aesthetics corresponding to the natural tooth, prosthetic teeth, but also other prefabricated materials for prostheses, such as, for example, CAD/CAM blocks, often have a multipart design that corresponds to the different regions of the tooth (enamel and dentin area). The older DE 36 10 683 proposes to use a soft-elastic core, which is manufactured separately in a complicated sequence of steps out of (meth)acrylates and copolymerizable urethane oligomers, and then introduced into the cavity to produce the complete prosthesis, after which the remaining cavity is filled with a hard, polymerizing plastic and polymerized. It is known that both ceramic and PMMA-based prosthetic teeth can sometimes consist of up to six layers, which must each be manually inserted into the prosthetic tooth mold. Due to this and other complex processes with many manual steps that have already been proposed, the previous manufacture of prosthetic teeth is a very labor, time and therefore cost-intensive process. Another example, in addition to the aforementioned CAD/CAM blocks for single/multi-layer crowns, are prefabricated single/multi-layer crowns that are finished via a CAD/CAM process. The advantage of prefabricated crowns, compared to CAD/CAM blocks, is a substantial material, time, and thus cost savings. In addition, inlays, onlays, veneers etc. are included as possible indications.

To achieve the desired appealing aesthetics, care is also often taken to ensure that the different layers have increasing translucency from the inside to the outside. EP 1 264 581 A1 discloses the production of a plastic tooth composed of at least two different, photopolymerizable compositions that are each formed of an inorganic or organic light and heat curable monomer, in particular of methacrylate compounds. The polymerization takes place in a mold such that first the transparent enamel material and then the dentin material is filled in layer wise and polymerized or prepolymerized, whereby a veneer is needed for shaping the enamel material. Post curing of both components together is possible.

However, the systems according to the state of the art have the following disadvantages in particular: after a certain period of wearing the prosthesis, PMMA-based prosthetic teeth often have to be replaced with new ones in order to counteract the wear. In some cases, a new prosthesis must be prepared. Both are connected with great effort, time and costs. Ceramic teeth can also be replaced, but the effort is greater. Sometimes ceramic teeth are repaired temporarily with composite. However, these are not permanent solutions. This problem also applies to prosthetic teeth that are prepared otherwise on a similar material base.

Given this situation, the inventors set themselves the task of providing dental prostheses with a multi-part design (complete prosthetic teeth or partial prostheses) for dentures, comprising at least a first, inner sub-region and a second outer sub-region, where the two sub-regions have physical properties that are similar to those of the dentin region or the enamel region of natural teeth. Preferably, the materials used for the two sub-regions should have chemical similarities such that a good connection between the two sub-regions is possible. The object also includes providing a method and a mold system for molding and curing the dental prosthesis according to the invention.

This object is achieved by providing dental prostheses as defined above, comprising a first, inner sub-region having a first organically polymerized material, and a second, outer sub-region having a second organically modified and organically polymerized silicic acid (hetero)polycondensate, where the first, inner sub-region has a flexural strength of above 80 MPa, preferably of at least 90 MPa and even more preferably of at least 95 or even at least 100 MPa according to DIN EN ISO 4049: 2009, and a smaller elastic modulus than that of the second, outer sub-region, while the second, outer sub-region has a flexural strength of at least 100 MPa, preferably of at least 120 MPa and even more preferably of at least 130 MPa according to DIN EN ISO 4049: 2009. The flexural strengths of the two sub-regions may be identical or different, whereby a high flexural strength of the outer sub-region (and optionally greater than that of the first, inner sub-region) is advantageous. Preferably, the outer sub-region is more translucent than the inner sub-region. Optionally, the dentin region and/or the enamel region may each be subdivided into further sub-regions whose properties are selected in a suitable manner such that they resemble the corresponding natural regions as closely as possible. Additional sub-regions may be present, for example, one that corresponds to a tooth base.

If the first inner sub-region is a purely organic material, similar (e.g., copolymerizable) or identical groups are used for the polymerization thereof as those that are used for the second, outer sub-region. These can be, for example, (meth)acryl-, in particular (meth-) acrylate groups, more preferably methacrylate groups. However, as compared to this embodiment, it is preferred that the first, inner sub-region also contains an organically modified and organically polymerized silicic acid (hetero)polycondensate.

Organically modified silicic acid (hetero)polycondensates with organically polymerizable groups are duromer curing materials. According to the invention, an optionally purely organic material, which can be used for the first, inner sub-region, should preferably cure as a duromer.

The organically polymerizing silicic acid (hetero)polycondensates that can be used according to the invention are obtained by organic cross-linking of organic condensates that have not yet polymerized. These preferably represent a common material basis for the production of all sub-regions provided for the respective dental prosthesis and can advantageously be selected in relation to each other, whereby properties such as aesthetics, impact resistance, breaking strength, elastic modulus, abrasion and the like, depending on the sub-region for which they are intended, can be adjusted by the exact composition of the chosen resin matrix, the filler type, and their proportions to one another.

A common feature of the employable silicic acid (hetero)polycondensates is residue bound by carbon to at least a majority of the silicon atoms, which generally carries at least one organically polymerizable group or a reactive ring, in particular a reactive cyclic ether group. An organically polymerizable group is to be understood in the context of the present invention such that this group is accessible to a polyreaction, in which reactive double bonds or rings transition into polymers under the influence of heat, light, ionizing radiation or induced by redox (e.g., with an initiator (peroxide or the like) and an activator (amine or the like) (addition polymerization or chain-growth polymerization). During the polymerization, molecular components are not split off, nor do they migrate or rearrange. In addition, in one embodiment of the invention these groups can also be accessible to a thiol polyaddition when a thiol is added; primary and secondary amines (especially with at least two, but also three, four or more amino groups) should also be able to bond. Alternatively, they may be accessible to a ROMP (ring opening metathesis polymerization). Examples of the latter are norbornene groups. The reactive double bond(s) of this group can be arbitrarily selected, for example, they can be a vinyl group or part of an allyl or styryl group. Preferably, it/they are part of a double bond that is accessible to a Michael addition, thus contain(s) an activated methylene group due to the proximity to a carbonyl group. Particularly preferred among these are acrylic acid- and methacrylic acid groups or their derivatives. The organically polymerizable group typically contains at least two and preferably up to approximately 100 carbon atoms. It can be bonded directly or via any coupling group to the carbon skeleton of the Si—C-bonded residue.

According to the invention, the term “reactive, cyclic ether group” is preferably understood as meaning a glycidyl group (epoxy group); however, it can also denote a cyclic ether group with four ring members, i.e., an oxetane. The glycidyl or oxetane group can be unsubstituted, or substituted with one, two or, in the case of an oxetane group, with three alkyl groups, with a vicinal-bonding alkylene group (e.g., a hexylene group) or—again only in the case of an oxetane group—with a vicinal-bonding alkylene group and an alkyl group.

In the present invention, the term “(meth)acryl . . . ” is to be understood as meaning that each can represent the corresponding acryl or methacryl compound or a mixture of both. The present (meth)acrylic acid derivatives include the acids themselves, optionally in activated form, esters, amides, thioesters and the like.

The organically modified silicic acid polycondensates of the invention may exclusively comprise silicon as a (semi) metal of the inorganic skeleton; other metal atoms may also be incorporated in this skeleton instead. The latter are referred to here as silicic acid heteropolycondensates. The term “silicic acid (hetero) polycondensates” shall comprise both variants. The condensates contain organic residues bound to silicon by carbon. They are hereinafter also referred to as “resins” or “resin systems”; as such, they have an inorganic Si—O—Si network and are accessible to an organic polymerization. The first, inner sub-region and/or the second outer sub-region of the dental prosthesis can be formed exclusively from the resin; however, they are preferably filled with fillers as needed, as discussed in more detail below. Instead, or in addition, other additives, such as dyes, can be present. The filled and/or other additive-containing resins are referred to as “composites” in the following.

To produce the prosthetic teeth and the dentures (the dental prostheses) using silicic acid (hetero)polycondensates for both of the above-mentioned sub-regions, different resins are typically prepared for each of these sub-regions or, preferably, composites using different resin systems and a preferably inorganic, often hybrid filler mixture. Silica nanoparticles and/or various dental glass particles can, for example, be used as fillers. The materials are chosen so that the cured composites each have high flexural strength but different elastic moduli in order to adapt their physical properties to those of dentin or to the enamel material of natural teeth.

The cured composites can be characterized by determining the mechanical properties, the wear behavior via in-vitro abrasion tests on the bite simulator, and the translucency. Pressure tests can be performed on the multilayer prosthetic teeth manufactured from composites.

The expert is familiar with the above-mentioned material base (silicic acid (hetero)polycondensates) from a large number of publications in a very large number of variations with different mechanical and optical properties. These silicic acid (hetero)polycondensates are also known under the name ORMOCER® (registered trademark of the Fraunhofer-Gesellschaft). These materials can deliver the necessary strength, hardness, abrasion resistance, aesthetics and/or biocompatibility, eliminate the existing disadvantages of ceramics or PMMA, and combine the positive aspects of both materials into one material. In addition, the adhesion promoter system mentioned further below can also enable a load-stable bonding, and in combination with the expandability/reparability enable a durable supply, thus enabling a significant cost reduction.

The manufacturing process can differ in terms of the process sequence used to produce the dental prostheses. On the material side, the consistency of the composites and their curing varies (photo-, thermal-, redox-induced). IR-curing also comes into question. Material systems that are used for the various layers of the tooth are preferably C═C and specifically (meth)acryl, norbornenyl- and also epoxy-functionalized resin/composite systems of organically modified silicic acid (hetero)polycondensates (as described in particular in DE 4011044, EP 0450624, DE 4133494, DE 4310733, DE 4416857.8, DE 19627198, DE 19910895, DE 10349766.8 and EP 1914260, DE 102005018351, DE 102005018059, DE 102011054440.2, DE 102011053865.8, DE 102012109685.6, DE 102013108594.6 and DE 102014115751.6) with the chemical/physical properties necessary for the requirement profile. Less preferred, but possible, is also the use of purely organic, organic polymerizable resins/composites with said groups that are accessible to organic polymerization. At least the outer sub-region of the prosthesis should, however, be formed by a resin or composite containing an inorganic-organic hybrid material (silicic acid (hetero)polycondensate), because this allows to achieve a high flexural strength with a suitably high elastic modulus and high abrasion resistance for the final outer layer.

Composites can in particular be used as material, whereby preferably functionalized, often hybrid particle mixtures can be incorporated into selected ORMOCER® resins (i.e., silicic acid (hetero)polycondensate resins). Fillers (in the nm-μm range) that can be used are various commercial methacrylate functionalized dental glass particles and aerosols and/or spray-dried functionalized particles or those prepared according to the Stöber process. For a homogenous distribution and dispersion of the fillers in the resin matrix, a speed mixer, a planetary mixer and/or a three-roll mill can, for example, be used. Depending on the mixing principle, shear forces with differently strengths can act, and optionally temperature and/or vacuum can be used. By tuning the filler types/combinations and the quantity and distribution of the fillers in the ORMOCER® resins, the rheological, mechanical, and aesthetic properties are modified. The refractive indices are adjusted by varying the combination of fillers and by functionalizing the ORMOCER® resins with refractive index-modifying, preferably refractive index-enhancing groups (e.g., thio or aryl groups) so that different translucent composites for the dentin and enamel composite are available. The aesthetics of the composites is controlled by means of translucency/color measurement. Methacrylate groups of the resin systems (and likewise optionally to be incorporated functional groups, such as, for example, OH groups) can, on the one hand, contribute to the curing of the composites and, on the other hand, serve as potential functional groups for binding of adhesion promoter molecules.

The following aspects are important for the materials, particularly for the composites for the more opaque dentin core:
In the context of the invention, more cost-effective materials (for filler and matrix) can be selected, which is advantageous because prosthetic teeth are generally a mass product.
It is desirable, but not absolutely essential, to make the core relatively opaque, so that any underlying metal parts of a prosthesis do not show through and change the tooth color.
The material is selected such that it is fracture tough in the cured state.
The material is selected such that it can preferably be cured thermally and/or by radiation, particularly preferably by IR.
In many cases, it is advantageous for the breaking strength to exceed that of comparable PMMA materials (approximately 93 MPa).
Chemical bonding to the enamel layer should be enabled during the manufacture, for example by sandblasting with or without an adhesion promoter system, or due to the presence of chemical (reactive) groups that are identical in the dentin and the enamel layer
Chemical bonding to the prosthesis base material should be given (optionally by sandblasting, with or without an adhesion promoter system).

The following aspects are important for the materials, in particular the composites for the more translucent enamel layer:
In the context of the invention, more cost-effective materials (for filler and matrix) can be selected, which is advantageous because prosthetic teeth are generally a mass product.
It is desirable, but not absolutely essential, to make the outer layer of enamel as translucent as possible, so as to ensure the most natural possible aesthetics of the prosthetic teeth.
The material is selected such that it can preferably be cured thermally and/or by radiation, particularly preferably by IR.
The breaking strength should exceed that of comparable PMMA materials (approximately 93 MPa).
The material should have a high hardness and high wear resistance in the cured state.
The chemical bonding to the dentin composite can be accomplished because of groups specific to each of the materials without further action; alternatively, the surface of the dentin composite may be roughened by sandblasting and/or provided with an adhesion promoter.

The translucency of the composites can be adjusted within wide ranges by varying the matrix, the filler type, the filler size, and the filler content.

According to an advantageous embodiment, an adhesion promoter system is used for the two or multi-layered prosthetic teeth. This ensures durable bonding between the individual layers, which is stable under load, and the ability to expand/repair the materials used. In particular, a (bi-) functional adhesion promoter is used for the chemical bonding of the two tooth layers that is adapted to the composite system (e.g., a monomeric or oligomeric compound having two identical or different reactive groups), which bonds the first already cured layer with the subsequently applied pasty composite. The selected adhesion promoter firmly binds by chemical and/or physical action (retentively) to the dentin composite and generates a load-stable bond with the enamel composite, which is still in the organically non-crosslinked state at the time of processing. Complete “sealing” by optimal bonding is advantageous, so that saliva, food residues, and microorganisms cannot enter between the dentin and the enamel composite layer. This would inevitably lead to discoloration or separation of the composite layer.

Adhesion promoter systems for dental repair materials are described in particular in DE 10 2012 104 139 A1. The skilled person can find detailed instructions there on which adhesion promoters are suitable for which silicic acid (hetero)polycondensate resins or -composites. This selection depends mainly on the functional groups that, on the one hand, are already present on the solidified core surface and on the organic groups on the enamel mass on the other. If groups are identical, the adhesion promoter can be selected from difunctional compounds that polymerize with these groups under the conditions required for the enamel mass to cure. If the groups are different, an adhesion promoter with different functional groups should be selected, where some of these groups can react with groups on the surface of the dentin core, and others with groups of the enamel mass.

According to the invention, composite enamels are preferably prepared and employed that have a very high flexural strength (greater than 130 MPa, preferably of at least 150 MPa up to, for example, 169 MPa) and a large elastic modulus (in the range of over 7.5 GPa, preferably of approximately 11 GPa or above, for example, 13.0 GPa) and high hardness (specifically, 91 HV1/10 were achieved). Further, a large wear resistance could be achieved. Corresponding preferred dentin composites of the present invention also have high strength (greater than 130 MPa, preferably of at least 150 MPa to 159 MPa, for example) and a smaller elastic modulus than the composite enamel used in combination therewith (preferably 5 to 7.0 GPa, for example, 6.5 GPa). High translucency of over 55%, preferably of at least 60% is further desired. With such combinations of enamel and dentin composites, the principle of the hard shell and the flexible core can be realized particularly well.

The dental prostheses according to the invention are in particular individually manufactured according to the requirements of an individual patient. It is usually possible to form the dental prostheses according to the invention as almost fully anatomical prefabricated forms, which require only minor adaptations for insertion in a patient's mouth. Alternatively, although less preferred, they may also be prepared in the form of blocks, which are subsequently prepared via a personalized process, for example, CAD/CAM, for a specific patient.

In connection with the aforementioned load-stable and thus durable and potentially repairable material system, a novel mold system further enables an easy, optionally automated, prosthetic denture preparation, such as e.g. for prosthetic teeth, onlays, crowns or veneers.

This system is composed of modular molds. With its help, a simple, potentially also automated, prosthetic tooth preparation, such as e.g. for prosthetic teeth is enabled. Due to the modular design, the transition of the process from a single layer to a multilayer system is easy to implement. The mold allows the production of high quality monolayer or multilayer teeth/crowns by means of a load-stable and thus durable, potentially even repairable, material system. The process can differ with respect to the structure and the material of the mold (e.g., metal or translucent materials, such as glass) and the procedure with respect to the preparation of the teeth, which will be explained in more detail below.

The modules of the mold system are preferably composed of metal, but optionally of glass instead or a different material, preferably permeable for electromagnetic radiation, such as light or infrared radiation, or an appropriate combination of materials; they can be single tooth or multiple teeth molds (see FIG. 5). The latter are suitable when several dental prostheses are to be prepared as prefabricated molds or blocks, which are personalized later, as described above. All surfaces of the mold are designed such that the complete removal of the prosthetic tooth is ensured. This can, for example, be achieved by high-gloss polishing of the mold or by providing its lining with a non-stick coating, if the surface of the mold as such does not have a sufficiently smooth surface.

To prepare the dental prostheses consisting of at least two layers which, as mentioned above, are to be composed of duromer-material, a multi-part mold system is used, which consists of at least a first and a second negative mold for the production of dental prostheses having an inner region and at least one additional sub-region, where the second negative mold is formed such that it forms a second cavity that essentially has the shape of the dental prosthesis, where
(a) each negative mold consists of at least two parts, and
   (i) the first negative mold is formed such that a first cavity is formed which has a smaller volume than the second cavity, and where the geometry of the first cavity is selected such that the full or partial surface of an inner region (interior part) of the dental prosthesis prepared in the first negative mold is coated in the second negative mold with an outer layer or can be provided with the at least one other sub-region, so that the finished dental prosthesis or the inner region and the at least one additional sub-region is/are formed and/or
   (ii) the second negative mold consists of one of the parts of the first negative mold, and an additional part,
      or
(b) the first negative mold is a single part and has an opening for the admission of electromagnetic radiation (e.g., light in the visible region or radiation outside thereof, for example, IR radiation), and the second negative mold consists of the first negative mold or a first part of a second negative mold each in combination with a second part, where the molds are designed such that together they form a cavity having a geometry that is selected such that a the full or partial surface of the inner region of the dental prosthesis prepared in the first negative mold is coated in the second negative mold with an outer layer or can be provided with the at least one other sub-region so that the finished dental prosthesis or the inner region and the at least one other sub-region is formed, where, after having been assembled from the respective parts, all named negative molds have at most one or two openings from which excess resin and/or air can escape.

Due to the materials to be used according to the invention, the mold system is designed for duromeric curing. This means that the material is generally filled into the open mold. The assembled molds accordingly do not have a filler neck, such as is needed for thermoplastic injection molding, or a pressure relief valve, and the mold system can be filled independently of any pressure applied, other than the fact that low-pressure can occur when a syringe or the like is used for filling. A small opening is advantageously, but not always necessarily, present in the second (most often the top) part of the negative mold if possible, if such a second part is provided, through which potentially excess resin or air can escape. A second such opening in a different part of the negative mold is not excluded in some embodiments, if it facilitates draining of excess material or escaping of air. The mold system of the present application is thus significantly more cost-effective and easy to build than a comparable mold system designed for thermoplastic injection molding.

For the sake of simplicity, the preparation is shown only once using the example of two-layer prosthetic teeth consisting of a dentin core and an enamel layer, in a simplified tooth shape. However, the method can be applied/adapted to a multilayer system with more than two layers by providing third and optionally additional two-part negative molds of the type described hereinafter. The principle thereby applies that the tooth or the prosthetic part is built up from the inside out, i.e., an inner core is produced first that is then surrounded by additional layers of material.

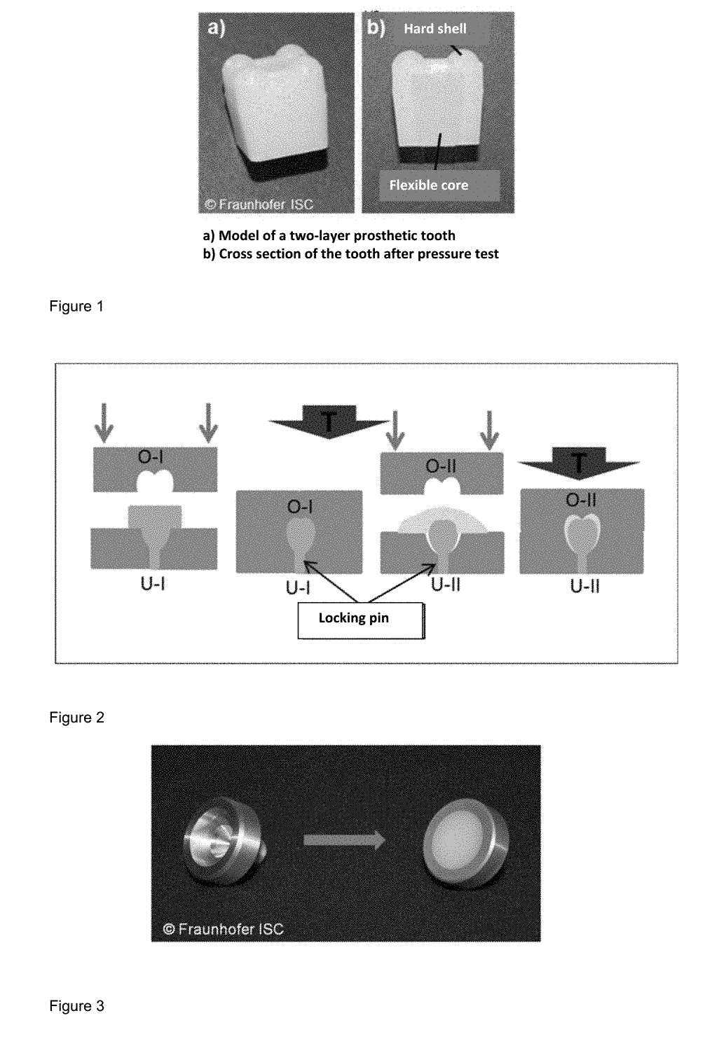

As mentioned, the mold system according to the invention is modular; it consists of several mold parts. A schematic diagram of a first embodiment of the mold system is shown in FIG. 2. The corresponding mold sets are available for producing high quality monolayer or multilayer teeth or for monolayer or for monolayer or multilayer crowns that enable a partial/full automation of the process. The principle of the mold system of FIG. 2 is based on the principle “one mold per sub-region composed of at least two parts,” where first by means of a first mold consisting of at least two partial molds a core is formed, usually the dentin core, which is then transferred to a second mold in which it is provided with additional material for the next region. If the prosthetic tooth is to be constructed in two parts, then it relates to the enamel area. If the prosthetic tooth is to have multiple layers around the dentin core, it can relate to an outer dentin or inner enamel region, which, for example, exhibits a slightly higher elastic modulus and/or a slightly higher translucency than the core, but does not yet have the values that the outermost region is intended to have. A base region can also be attached to the dentin core.

At least the second negative mold therefore consists of at least (and usually not more than) two mold parts, which together have the contour of the negative mold for the entire tooth or denture. In variant (a), which may be designed as shown in FIG. 2, the negative mold for the first cavity (for the dentin core) consists of such a two- or multi-part mold. In the first embodiment (i) of this variant, the dentin core can be removed from the mold after it has solidified and transferred to the next mold. This leaves open the possibility to form the second (or a further) sub-region over large areas of the surface, for example, deeply into the lateral region, which in the natural tooth forms the neck of the tooth. In the second embodiment (ii) of this variant, a part of the first negative mold, for example its top part, can be removed after the core has solidified, and replaced by another top part with a larger cavity to form the second sub-region, while the solidified core region remains in the other part of the first negative mold. This is more cost-effective and technically simpler, but does not quite allow for the freedom of forming the second sub-region as described for the first embodiment (i) of variant (a).

The resin or composite is solidified in all variants (a) preferably by heat, in particular when metal molds are used. It can then also be photo-induced (for example, by light) or performed by means of IR radiation if at least one of the sub-forms consists of glass or another material that transmits radiation. A combination (photo-induced/IR-induced curing of the core and heat-induced curing of the enamel region or vice versa) is of course also possible.

In variant (b) the top mold part of the first negative mold is not used. The resin or composite resin is filled into the form, for example, up to its upper edge. This is possible because the shape of the dentin core does not have to exactly match the natural conditions; only the outer shape must have the geometric conditions required to insert the prosthetic tooth. Because of the absence of the upper portion of the mold, the dentin core can be solidified in this variant by means of radiation (for example, light-induced or by means of IR). Variant (b) is shown schematically in FIG. 6.

The negative molds extend upwardly preferably slightly conical to facilitate the removal of the tooth prosthesis after polymerization. As mentioned, for teeth that are constructed in two pieces, two negative molds are required, the first for the dentin core and the second for the finished tooth, where an enamel or dentin region was applied to the core. In FIG. 2 the individual molds are each subdivided into a bottom part and a top part (bottom part U-I and top part O-I for the core, bottom part U-II and top part O-II for the entire tooth); of course, the molds can also be assembled laterally or with a different geometry.

In addition to the cavity formed by the mold, which is provided for the dentin core or for the tooth constructed subsequently with one or more layers, another cavity is provided in many embodiments of the invention that is directly adjacent to the cavity intended for the core or tooth and which can optionally extend to the outer side of the mold. It can, for example, be formed as a round opening with a diameter of about 3 mm in the center and over the entire height up to the bottom (basal side) of the later tooth; it is also filled with resin or composite and serves as a locking and/or catch pin during the further processing or storage. The circular opening may be constructed as a shape, for example, in the bottom part; but it can also be formed in the area where the two molds meet, for example, by corresponding half-shells.

According to the invention, to produce the teeth, a first resin or composite is filled into one of the moldings for the inner region of the later tooth, which can, for example, be accomplished by means of a syringe. The mold is optionally closed with the second or the other mold parts, which in more rare cases can also already contain resin, for example, in the case that undercuts or the like are present into which the resin can be easily pushed using a syringe, a spoon, or a different tool when the mold is open. The resin or the composite is subsequently thermally cured. To achieve a better flow behavior of the resin or composite, the mold is thereby optionally preheated at an elevated temperature. The thermal solidification can occur, for example, at 100° C. for several hours; it can be conducted at this stage, but does not need to, until the curing is complete. The solidified core is then optionally removed from the mold. This is achieved, for example, by pressing the locking pin from the outside toward the core. The core can then optionally be sandblasted and/or coated with an adhesion promoter in the regions where it is to be overlaid with the enamel region. Then it is optionally used for one of the mold parts for the next mold that also has space to accommodate the locking pin. The option presents here to select a more generous cavity for the already cured locking pin that extends from the inner tooth mold itself to the outside of the mold: if the locking pin is not positioned in the mold such that it is completely sealing, excess resin can be pushed to the outside through the channel that is formed between the arresting pin and the mold during closing. This can optionally make an opening otherwise provided in the mold superfluous. The resin or composite is filled into the mold, again optionally with heating, for the next or outermost (enamel) layer, for example, by means of a syringe. An opening in one of the parts, in particular in the top part, can serve as an outlet for excess material. Thermal solidification follows as described for the core. If the core was not fully cured, the conditions can be selected such that when the enamel layer is solidified the core is also completely cured; this version improves the chemical bonding of the two regions to one another. In another alternative, the solidification in the molds does not continue until curing is complete but only after de-molding of the tooth by heat or light.

After the tooth is removed from the mold, the locking pin is detached from the tooth, provided it is not needed in whole or in part as a protrusion of the prosthetic tooth for further processing steps or for later use (e.g., as mechanical anchor for an implant or the like).

These molds create the potential for a more effective manufacturing process, with which a higher volume per unit time can be reproducibly prepared.

A process for the preparation of the prosthetic teeth will be described in more detail in the following with reference to FIG. 2 as an example of a two-layered prosthetic tooth:

Four different molding parts are used (bottom part U-I and U-II, top part O-I and O-II). The bottom part U-I together with the top part O-I, and likewise U-II with O-II, form a two-part mold, which represents the negative mold for the dentin region of the prosthetic tooth. In addition, a circular opening (diameter, for example, approximately 3 mm) is located centrally over the entire height of the bottom mold part U-I (likewise U-II) to the bottom (basal side) of the later tooth. The dentin composite can then for example be filled into the bottom part U-I using a “syringe” (optionally with a defined applied pressure), whereby the circular opening in pin form is regularly filled in as well and can then serve as a locking and catch pin. The mold is then closed with the top part O-I; as a rule, the material is then thermally cured. The polymerized dentin core is removed from the bottom part U-I and, by means of the gripping pin which serves as a locking pin at the same time, can be placed in the bottom part U-II, which together with the top part O-II forms the negative mold of the final tooth including the enamel region. In many cases, the dentin region is then sandblasted and/or treated with an appropriate adhesion promoter system, and the bottom part U-II is filled with enamel composite, for example, using a “syringe.” The top part O-II is applied to the bottom part U-II and the material is thermally cured in the mold. The filling is carried out such that the cavity that is being formed (formed from top part O-II and bottom part U-II) is completely filled. Finally, after the tooth prosthesis is removed from the mold, the pin can be removed from the bottom side of the tooth.

The systems and prosthetic teeth according to the invention have at least some, but typically all, of the following advantages:
Easy to use modular mold for producing dental prostheses
   Effective production of prosthetic teeth or prefabricated materials for tooth replacement and realization of a partial/full automation with high production throughput while maintaining consistent quality
   Replacement of the previously labor/time-consuming and thus expensive procedure due to a more effective process
Load-stable biocompatible material systems
   Aesthetics/translucency adapted to the natural tooth through multilayer construction
   High abrasion resistance of e.g., prosthetic teeth with good chemical bonding to the prosthetic base and good reparability
   Optionally monomer-free and thus biocompatible material base, thereby providing toxicological and allergological safety for use as a tooth replacement material
   Increased wear comfort as compared to ceramic teeth (no “chattering”)

With the described novel modular multipart molds in conjunction with a load-stable material system, single/multilayer prosthetic teeth, CAD/CAM blocks for single/multi-layer crowns, prefabricated CAD/CAM single/multilayer crowns and inlays, onlays and veneers can be generated. In addition, this enables the development of an automated and therefore cost-effective production of aesthetical and high quality dental prostheses.

The inventive molding system is particularly suitable for, but not limited to, use in combination with the inventive materials based on silicic acid (hetero)polycondensates (resins, composites). It is also suitable for producing multi-part dental prostheses made of purely organic materials, in particular those with organically cross-linkable groups, such as those listed for inorganic-organic hybrid materials, or a combination of at least one purely organic material with at least one organically polymerizable silicic acid (hetero)polycondensate. In the latter case, the outer or the outermost layer (enamel layer) is preferably, but not mandatorily, formed of the inorganic-organic hybrid material.

In the following, the invention is explained in more detail with reference to specific exemplary embodiments.

### A. MEASUREMENT METHODS

### (1) Test Body Preparation and Performance—Vickers Hardness Test

The test body was prepared and tested according to the test standard DIN EN 843-4
The hardness was determined by preparing test discs 2 mm in height and with a diameter of 18 mm using a non-stick-coated stainless-steel mold
A glass plate covered with PET film was used as an even surface
Filling in the degassed resin/composite
A glass plate covered with PET film was placed on top of the composite as an even surface
After curing (as described in the Examples) the test bodies were removed from the molds
Storage was at room temperature
The test was performed with the hardness tester V-100-C1 from Leco
The measurement was performed with a force of 1 kp for a holding time of 10 s.

### (2) Test Body Preparation and Performance—Three-Point Bending Test

The test body preparation and testing was carried out according to the test standard DIN EN ISO 4049: 2009
To determine the flexural strength and the elastic modulus, cuboid test rods with dimensions of 2 mm×2 mm×25 mm were prepared by means of non-stick metal molds
Filling in the degassed resin/composite
To prevent the formation of an oxygen inhibitor layer, the resin/composite that was filled into the mold was covered with a level layer of polyethylene terephthalate (PET) film
After curing (as described in the Examples), the rods were removed from the molds and both side surfaces sanded using sandpaper with a grain size of 1200 for demolding, and stored as described in the Examples.
Storage was at 40° C. for 24 hours for the thermally cured rods or 36 hours for the photocured rods
The universal test machine Z100 from Zwick/Roell was used as the test device.
The measurement was thereby performed with a standard force transducer of 100 N. The span length of the support rollers was 20 mm, their radius and that of the bending punch was 1 mm and the test speed 3 mm/min.

Overview of existing materials

| | Natural dentin-enamel | PMMA | Glass ceramics |
|---|---|---|---|
| Flexural strength | n.d. | 50-130 | 150-420 |
| [MPa] | | | |
| Elastic modulus [GPa] | 11-85 | 2.0-3.5 | 30-95 |

In contrast to natural dentin/enamel, PMMA demonstrated a very low elastic modulus, resulting in a high self-abrasion. Glass ceramics show very high values with respect to strength and the elastic modulus is in the range of natural dentin/enamel. A disadvantage of glass ceramics is the extensive processing and the deficits noted in the description.

Minimum requirements on the inventively employable
resins/composites (in the cured state)

| | Melting range | Dentin range |
|---|---|---|
| Flexural strength [MPa] | >100 | >80 |
| Elastic modulus [GPa] | >7.5 (preferably >11) | >5 |

The strength and elastic modulus of the dentin core should have the minimum values shown in the table. As the outer layer, the enamel composite should, among other factors, achieve a high level of abrasion resistance with respect to strength/elastic modulus that are ideally in the range of natural dentin-enamel.

### (3) Preparation of Test Specimens and Performance—Translucency Measurement

Round test discs 2 mm in height and with a diameter of 18 mm were prepared from the composites using stainless steel molds. PET films were used to obtain an airtight seal on the top and bottom sides of the composite, and glass plates used to provide smooth contact and coverage areas. The thermally curing composites were cured at 100° C. for 4 h in the oven and the light-curing composites for 100 s with a blue light emitter (wavelength of approximately 380-520 nm) from both sides at a distance of 0.5 cm, respectively. The translucency measurement was performed with a spectrophotometer Color i7 from X-Rite over a wavelength range of 360 to 750 nm.

### B. PREPARATION OF TEST SPECIMENS AND ANTAGONISTS AND PERFORMANCE OF THE ABRASION TESTS

The wear behavior of composites was investigated using the chewing simulator CS-4.8 from SD Mechatronik. The specimens were embedded using sample holders of aluminum having a diameter of approximately 1.5 cm (see FIG. 3, which shows the sample holder before and after preparation of the composite). An excess of the corresponding composites was filled in the sample holder. The thermally curable composites were cured at 100° C. in the oven for 4 hours, the light-curable composite cured for 100 s with a blue light emitter (wavelength between approximately 380-520 nm) at a distance of 0.5 cm. The cured test specimens were stored for 24 hours at 23° C. and at a humidity of 40% until testing and prior to the measurement sanded flat using a sander with sending paper with a grain size of 4000 at 300 rpm.

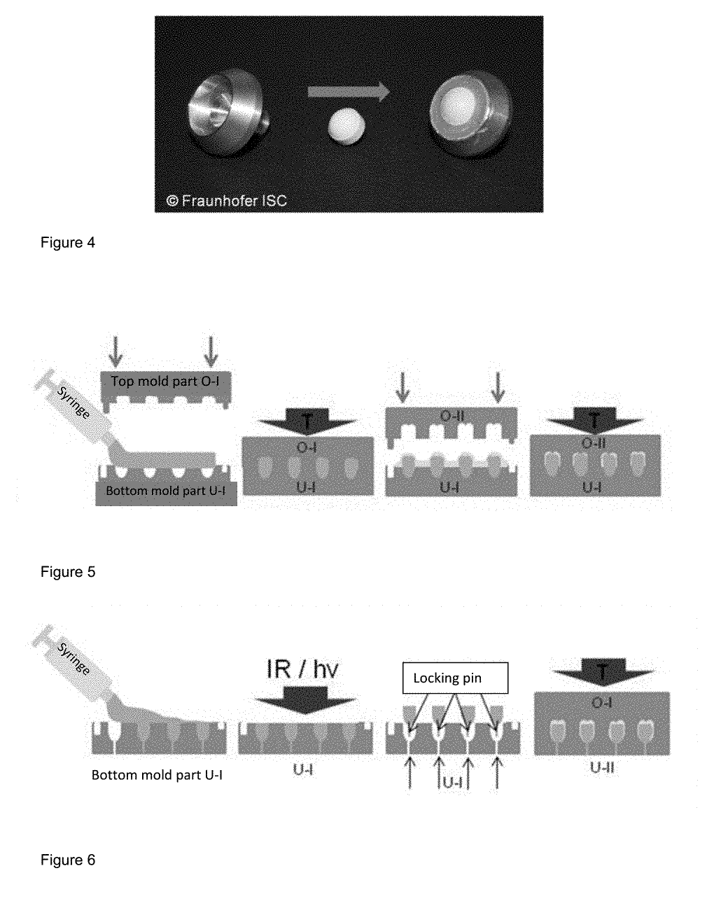

For embedding the antagonists (abrading body), tapered antagonist holders of aluminum with a diameter of about 1.5 cm were used. Balls of Degussit, a high-density aluminum oxide ceramic, with a diameter of 5 mm were used as antagonists and fixed with PMMA. FIG. 4 shows such an antagonist holder of aluminum before and after preparation with the Degussit antagonist balls.

The sample holders prepared with material are mounted in the sample chambers and the prepared antagonist holders to the antagonist's punches.

The following test parameters were set on the device:

Load of samples during the test: 5 kg per sample

| | | |
|---|---|---|
| Up and downward stroke: | 2 | mm |
| Up and downward speed: | 60 | mm/s |
| Horizontal movement: | 1 | mm |
| Horizontal speed: | 40 | mm/s |

| | |
|---|---|
| Movement cycles: | 300,000 |

The options “time-optimized movement” and “minimum impulse on impact” were activated.

The following settings were used for the thermocycling:

Temperatures of the rinse water: 5 and 55° C.

| | |
|---|---|
| Rinsing time: | 30 s |
| Draining time of the water | 11 s |

### C. EXAMPLES FOR THE PREPARATION OF THE RESINS AND COMPOSITES

### C1. Resin Systems

### C1A. Resin System A (Synthesis According to DE 44 16 857 C1)

Triphenylphosphine as catalyst, BHT (3,5-di-tert-butyl-4-hydroxytoluene) as stabilizer and then 47.35 g (0.550 mol) of methacrylic acid are added dropwise to 125.0 g (0.503 mol) 3-glycidyloxypropylmethyldiethoxysilane under a dry atmosphere and stirred at 80° C. (approximately 24 h). The conversion can be followed by the reduction of the carboxylic acid concentration by means of acid titration and the epoxide conversion by epoxide titration/NMR. After addition of ethyl acetate (1000 ml/mol silane) and H₂O for hydrolysis with HCl as catalyst, the mixture is stirred at 30° C. The reaction is worked up after several days of stirring by shaking out with aqueous NaOH and water and filtrating through a hydrophobic filter. The mixture is first spun off and then drawn off under an oil pump vacuum. The result is a liquid resin with a viscosity of ≈3-5 Pa·s at 25° C. and a refractive index n_{D}≈1.477.

### C1B. —Resin System B (from DE 10 2014 115 751)

### 1st Step

### Reaction Scheme:

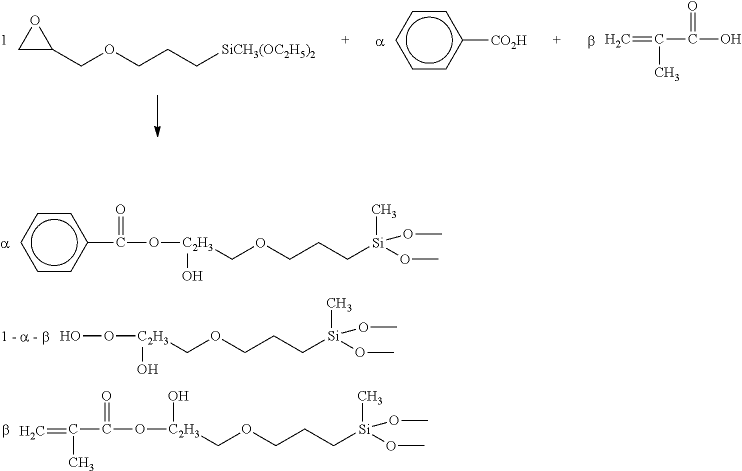

(Proportion of educt: α=0.6, β=0.42):

0.42 g triphenylphosphine as catalyst, 0.04 g BHT (2,6-di-tert-butyl-4-methyl phenol), 14.7 g (0.12 mol) of benzoic acid and then 7.23 g (0.084 mol) of methacrylic acid are added to 50.2 g (0.202 mol) 3-glycidyloxypropylmethyldiethoxysilane and stirred at ≈85° C. (approx. 24 h). The reaction can be followed as described in Example C1A. After addition of ethyl acetate (1000 ml/mol silane) and H₂O for hydrolysis with HCl as catalyst, the mixture is stirred at 30° C. The course of hydrolysis is followed by water titration. The reaction is worked up after several days of stirring by shaking out with aqueous NaOH and water and filtrating through hydrophobic filter. The mixture is first spun off, and then drawn off under an oil pump vacuum. The result is a liquid resin without the use of reactive diluents (monomers) with a viscosity of about 19-26 Pa·s at 25° C. and a refractive index n_{D}≈1.506.

### 2nd Step

Note: the isocyanate group reacts not only with the hydroxy group of the 1st stage reaction products, but also with the vicinal hydroxy groups of the unreacted starting material if its cyclic ether groups were opened hydrolytically; a mixture of isomers results.

6.52 g (0.042 mol) isocyanatoethyl methacrylate is added dropwise to 19.9 g (0.07 mol based on Si) of the 1st stage reaction mixture and optionally 0.026 g BHT under a dry atmosphere at 30° C. with stirring and further stirred at 30° C. The reaction can be followed via the reduction of the OCN band by IR spectrum. The band characteristic of the OCN group appears in the IR spectrum at 2272 cm⁻¹ The result is a liquid resin with a viscosity of approximately 102-128 Pa·s at 25° C. and a refractive index n_{D}≈1.504.

### C1C. Resin System C (from WO 2015/018906 A1)

### 1st Step: Basic Reaction Principle:

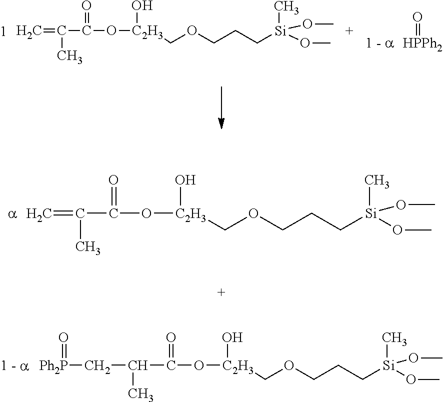

(1−α=0.2):

2.48 g (0.0123 mol) of diphenylphosphine oxide and 0.2 ml of 1,8-diazabicyclo[5.4.0] undec-7-ene (DBU) as catalyst are added to 16.0 g (0.0615 mol) of resin system A with stirring. The resulting reaction mixture is stirred at ≈50° C. until addition is completed. The reaction can, for example, be followed by NMR. After conventional work-up, e.g., in ethyl acetate (shaking out with water, filtrating through hydrophobic filter, spinning off and subsequent drawing off with an oil pump vacuum) a liquid resin results with a viscosity of approximately 37 Pas at 25° C. and a refractive index n_{D}≈1.500.

### 2nd Step:

17.2 g (0.4 mol) of methacrylic acid-isocyanatoethyl ester are added dropwise to 83.2 g of the product of step 1 (molar ratio=1:0.4) and optionally 0.043 g BHT (2,6-di-tert-butyl-4-methyl phenol) under a dry atmosphere at 30° C. with stirring, and stirring continued at 30° C. The conversion can be followed e.g., via the reduction of the OCN band by IR spectrum. The band characteristic of the OCN group appears at ≈2272 cm⁻¹ in the IR spectrum. The result is a liquid resin with a viscosity of approximately 98 Pa·s at 25° C. and a refractive index n_{D} of approximately 1.500. Further work-up is usually not required.

### C1D. Resin System D (from WO 2015/018906 A1)

### 1st Step: (1st Variant: Ratio Resin System A:Thiophenol=1:0.4)

6.61 g (0.079 mol) of thiophenol are added dropwise to 39.7 g (0.15 mol) of resin system A with stirring. The result is a liquid resin with a viscosity of approximately 7.0-7.2 Pas at 25° C. and a refractive index n_{D} of approximately 1.506. Further workup is not required.

### 1st Step: (2nd Variant: Ratio Resin System A:Thiophenol=1:0.45)

22.8 g (0.207 mol) of thiophenol are added dropwise to 121.4 (0.460 mol) of resin system A with stirring. The result is a liquid resin with a viscosity of approximately 6.9-7.0 Pas at 25° C. and a refractive index n_{D} of approximately 1.508 (the slightly increased refractive index is due to the higher thiophenol proportion). Further workup is not required.

### 2nd Step:

### Basic Reaction Principle:

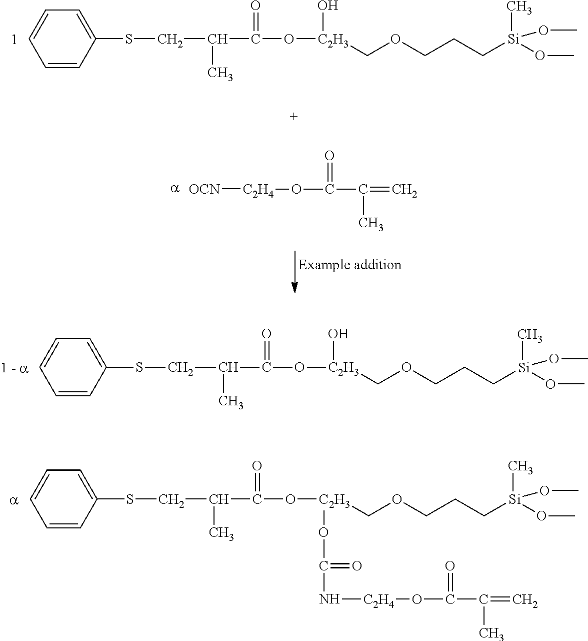

(α=0.8):

1st variant: 6.21 g (0.04 mol) of methacrylic acid-isocyanatoethyl ester are added dropwise to 15.4 g of first stage product, 1st variant (0.05 mol) and 0.043 g BHT (2,6-di-tert-butyl-4-methyl phenol) under a dry atmosphere at 30° C. with stirring and stirring continued at 30° C. The conversion can e.g., be tracked via the reduction of the OCN band by IR spectrum. The band characteristic of the OCN group appears in the IR spectrum at ≈2272 cm⁻¹. The result is a liquid resin with a viscosity of approximately 36 Pa·s at 25° C. and a refractive index n_{D} of approximately 1.502. Further workup is not required.

2nd variant: 54.6 g (0.352 mol) of methacrylic acid-isocyanatoethyl ester are added dropwise to 138 g of first stage product, 2^{nd} variant (0.440 mol) and 0.096 g BHT (2,6-di-tert-butyl-4-methyl phenol) under a dry atmosphere at 30° C. with stirring and stirring continued at 30° C. The band characteristic of the OCN group appears in the IR spectrum at ≈2272 cm⁻¹. The result is a liquid resin with a viscosity of approximately 43 Pa·s at 25° C. and a refractive index n_{D} of approximately 1.506. Further workup is not required.

### C1E. Resin System E (from DE 103 49877.8)

### Basic Reaction Principle:

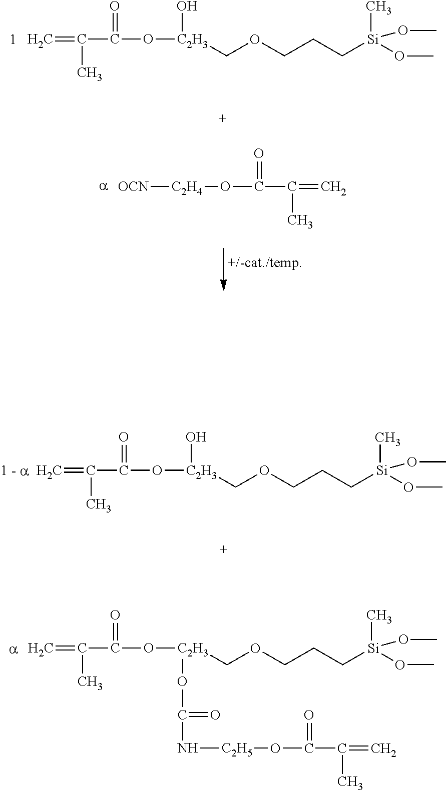

(Proportion of educt: α=0.7):

54.3 g of methacrylic acid-isocyanatoethyl ester (0.70 mol) are added dropwise to 130.3 g (0.50 mol) of the resin system A and 0.09 g BHT under a dry atmosphere at 30° C. with stirring and stirring continued at 30° C. After complete conversion, a liquid resin results with a viscosity of approximately 22-28 Pas at 25° C.

### C2: Composite and their Properties in the Cured State

The components given below are mixed, placed in molds, and cured using the indicated measures. The measurement of properties was performed by the determination methods above

### C2A. Composites for the Dentin Core

### Example C2A-a

50 wt.-% resin system B+2 wt.-% DBPO

50 wt.-% filler proportion, silanized (Schott GM32087 glass), consisting of 100 wt.-% Ultrafine, primary particle size: 0.4 μm (3 passages in the three-roll mill)

Thermal curing for 4 hours at 100° C., 1 d dry storage at 40° C.

Breaking strength: 136±9 MPa

Elastic modulus: 5.3±0.2 GPa

Translucency: 56%

### Example C2A-b

40 wt.-% resin system B+2 wt.-% DBPO

60 wt.-% filler proportion, silanized (Schott GM27884 glass), consisting of 100 wt.-% Ultrafine, primary particle size: 0.7 μm (3 passages in the three-roll mill)

Thermal curing for 4 hours at 100° C., 1 d dry storage at 40° C.

Breaking strength: 160±6 MPa

Elastic modulus: 6.8±0.3 GPa

Translucency: 68%

### Example C2A-c

40 wt.-% resin system B+2 wt.-% DBPO

60 wt.-% filler proportion, silanized (Schott GM27884 glass), consisting of
67 wt.-% Ultrafine, primary particle size: 0.4 μm (3 passages in the three-roll mill)
33 wt.-% Ultrafine, primary particle size: 0.7 μm (4 passages in the three-roll mill)

Thermal curing for 4 hours at 100° C., 1 d dry storage at 40° C.

Breaking strength: 159±5 MPa

Elastic modulus: 6.5±0.3 GPa

Translucency: 61%

### Example C2A-d

27 wt.-% resin system C+2 wt.-% DBPO

73 wt.-% filler proportion, silanized (Schott GM27884 glass), consisting of
18 wt.-% Ultrafine, primary particle size: 0.18 μm (3 passages in the three-roll mill)
14 wt.-% Ultrafine, primary particle size: 0.4 μm (3 passages in the three-roll mill)
68 wt.-% Standard Grind K6, primary particle size: 3 μm (6 passages in the three-roll mill)

Thermal curing for 4 hours at 100° C., 1 d dry storage at 40° C.

Breaking strength: 171±13 MPa

Elastic modulus: 10.6±0.1 GPa

Hardness: 81 HV

Translucency: 25%

### Example C2A-e

40 wt.-% resin system D (2nd variant)+1 wt.-% LTPO

60 wt.-% filler proportion, silanized (Schott GM27884 glass), consisting of
60 wt.-% Ultrafine, primary particle size: 0.4 μm (2 passages in the three-roll mill)
40 wt.-% Ultrafine, primary particle size: 0.7 μm (3 passages in the three-roll mill)

Light hardening for 2×100 s, 1.5 d dry storage at 40° C.

Breaking strength: 158±6 MPa

Elastic modulus: 6.3±0.223 GPa

Translucency: 62%

Hardness: 41 HV 1/10

### Example C2A-f

40 wt.-% resin system D (2^{nd} variant)+1 wt.-% LTPO

60 wt.-% filler proportion, silanized (Schott GM32087 glass), consisting of
40 wt.-% Ultrafine, primary particle size: 0.4 μm (2 passages in the three-roll mill)
60 wt.-% Ultrafine, primary particle size: 5 μm (5 planetary mixture)

Light hardening for 2×100 s, 1.5 d dry storage at 40° C.

Breaking strength: 154±10 MPa

Elastic modulus: 10.7±0.334 GPa

Translucency: 37%

Abrasion: 1.49 mm³ volume wear

Hardness: 78 HV 1/10

### Example C2A-g

50 wt.-% resin system D (2^{nd} variant)+1 wt.-% LTPO

50 wt.-% filler proportion, silanized (Schott GM27884 glass), consisting of
100 wt.-% Ultrafine, primary particle size: 0.7 μm (2 passages in the three-roll mill)

Light hardening for 2×100 s, 1.5 d dry storage at 40° C.

Breaking strength: 150±16 MPa

Elastic modulus: 5.5±0.370 GPa

Translucency: 75%

Hardness: 35 HV 1/10

### C2B. Composite for the Enamel Layer

### Example C2B-a

50 wt.-% resin system A+2 wt.-% DBPO

50 wt.-% filler proportion, silanized (Köstrosol 3550), consisting of 100 wt.-% of nanoparticles, primary particle size: 0.1 μm

Thermal curing for 4 hours at 100° C., 1 d dry storage at 40° C.

Breaking strength: 111±8 MPa

Elastic modulus: 4.4±0.1 GPa

Translucency: 73%

### Example C2B-b

30 wt.-% resin system A+2 wt.-% DBPO

70 wt.-% filler proportion, silanized (Köstrosol 3550 and Schott G018-307 glass), consisting of
25 wt.-% of nanoparticles, primary particle size: 0.1 μm
75 wt.-% Ultrafine, primary particle size: 0.7 μm (4 passages in the three-roll mill)

Thermal curing for 4 hours at 100° C., 1 d dry storage at 40° C.

Breaking strength: 165±13 MPa

Elastic modulus: 8.7±0.4 GPa

Translucency: 29%

### Example C2B-c

35 wt.-% resin system A+2 wt.-% DBPO

65 wt.-% filler proportion, silanized (Schott G018-307 glass), consisting of 100 wt.-% Ultrafine, primary particle size: 0.7 μm (4 passages in the three-roll mill)

Thermal curing for 4 hours at 100° C., 1 d dry storage at 40° C.

Breaking strength: 155±11 MPa

Elastic modulus: 7.7±0.3 GPa

Translucency: 66%

### Example C2B-d

30 wt.-% resin system A+2 wt.-% DBPO

70 wt.-% filler proportion, silanized (Köstrosol 3550 and Schott G018-307 glass), consisting of
25 wt.-% of nanoparticles, primary particle size: 0.1 μm
25 wt.-% Ultrafine, primary particle size: 0.4 μm (3 passages in the three-roll mill)
50 wt.-% Ultrafine, primary particle size: 0.7 μm (4 passages in the three-roll mill)

Thermal curing for 4 hours at 100° C., 1 d dry storage at 40° C.

Breaking strength: 155±11 MPa

Elastic modulus: 8.1±0.6 GPa

Translucency: 28%

### Example C2B-e

20 wt.-% resin system A+2 wt.-% DBPO

80 wt.-% filler, silanized (Köstrosol 3550 and Schott G018-307 glass), consisting of
25 wt.-% of nanoparticles, primary particle size: 0.1 μm
25 wt.-% Ultrafine, primary particle size: 0.7 μm (4 passages in the three-roll mill)
50 wt.-% Standard Grind K5, primary particle size: 5 μm (4 passages in the three-roll mill)

Thermal curing for 4 hours at 100° C., 1 d dry storage at 40° C.

Breaking strength: 169±7 MPa

Elastic modulus: 13±0.5 GPa

Hardness: 91 HV

Translucency: 22%

Abrasion: 0.47 mm³ (300000 cycles, 5 kg load)

### Example C2B-f

30 wt.-% resin system D+1 wt.-% Lucirin-TPO

70 wt.-% filler proportion, silanized (Schott GM27884 glass), consisting of
33 wt.-% Ultrafine, primary particle size: 0.7 μm (3 passages in the three-roll mill)
67 wt.-% Standard Grind K6, primary particle size: 3 μm (3×15 min in planetary mixer, 40 rpm)

Light-initiated curing 100 s on both sides, 1.5 d dry storage at 40° C.

Breaking strength: 151±11 MPa

Elastic modulus: 7.9±0.3 GPa

Translucency: 61%

### Example C2B-g

24 wt.-% resin system E+2 wt.-% DBPO

76 wt.-% filler proportion, silanized (Köstrosol 3550)+silanized Schott G018-307 glass consisting of:
14 wt.-% nanoparticles, primary particle size: 0.08 μm
36 wt.-% GM27884, primary particle size: 0.4 μm (2 passages in the three-roll mill)
50 wt.-% GM27884, primary particle size: 5 μm (5 passages in the three-roll mill)

Thermal curing for 4 h at 100° C., 1 d dry storage at 40° C.

Breaking strength: 159±6 MPa

Elastic modulus: 13.0±0.517 GPa

Translucency: 22%

Abrasion: 0.53 mm³ (300000 cycles, 5 kg load)

Hardness: 101 HV 1/10

### Example C2B-h

24 wt.-% resin system E+2 wt.-% DBPO

76 wt.-% filler proportion, silanized Schott G018-307 glass consisting of:
14 wt.-% G018-307, primary particle size: 0.4 μm (2 passages in the three-roll mill)
36 wt.-% G018-307, primary particle size: 0.7 μm (2 passages in the three-roll mill)
50 wt.-% G018-307, primary particle size: 5 μm (5 passages in the planetary mixer)

Thermal curing for 4 h at 100° C., 1 d dry storage at 40° C.

Breaking strength: 148±6 MPa

Elastic modulus: 11.7±0.735 GPa

Translucency: 38%

Abrasion: 0.85 mm³ volume wear

Hardness: 100 HV 1/10

### Example C2B-i

40 wt.-% resin system E+2 wt.-% DBPO

60 wt.-% filler proportion, silanized (Köstrosol 3550)+silanized Schott G018-307 glass consisting of:
29 wt.-% nanoparticles, primary particle size: 0.08 μm
71 wt.-% GM27884, primary particle size: 0.4 μm (3 passages in the three-roll mill)

Thermal curing for 4 h at 100° C., 1 d dry storage at 40° C.

Breaking strength: 151±10 MPa

Elastic modulus: 7.8±0.336 GPa

Translucency: 31%

Abrasion: 0.38 mm³ (300000 cycles, 5 kg load)

Hardness: 69 HV 1/10

### Example C2B-j

40 wt.-% resin system E+2 wt.-% DBPO

60 wt.-% filler proportion, silanized Schott G018-307 glass consisting of:
29 wt.-% GM27884, primary particle size: 0.4 μm (2 passages in the three-roll mill)
71 wt.-% GM27884, primary particle size: 0.7 μm (3 passages in the three-roll mill)

Thermal curing for 4 h at 100° C., 1 d dry storage at 40° C.

Breaking strength: 159±8 MPa

Elastic modulus: 7.4±0.224 GPa

Translucency: 60%

Abrasion: 0.71 mm³ (300000 cycles, 5 kg load)

Hardness: 70 HV 1/10

### Example C2B-k

27 wt.-% resin system C+2 wt.-% DBPO

73 wt.-% filler proportion, silanized (Schott GM27884 glass) consisting of:
18 wt.-% Ultrafine, primary particle size: 0.18 μm (3 passages in the three-roll mill)
14 wt.-% Ultrafine, primary particle size: 0.4 μm (3 passages in the three-roll mill)
68 wt.-% Standard Grind K6, primary particle size: 3 μm (6 passages in the three-roll mill)

Thermal curing for 4 h at 100° C., 1 d dry storage at 40° C.

Breaking strength: 171±13 MPa

Elastic modulus: 10.6±0.1 GPa

Hardness: 81 HV 1/10

Translucency: 25%

### D. EXAMPLES FOR THE PRODUCTION OF MULTI-LAYER PROSTHETIC TEETH

### Example D1

The moldings parts are coated with a non-stick coating and for better flow behavior of the composite brought to a temperature of 45° C. First, the bottom mold- and top mold of the dentin mold are filled with dentin composite (see FIG. 2), which is also preheated to 45° C., using a syringe. Then, the top mold is placed onto the bottom mold part, the mold is closed and the composite cured at 100° C. in the oven for 4 h (suitable for the Denton composite with DBPO as initiator in the specific case; may be optionally changed). After the mold is opened, the polymerized dentin core is pushed out from below using the locking pin, sandblasted to achieve mechanical retention, and then inserted into the bottom part U-II, which together with the top part O-II represents the negative mold of the final tooth plus enamel region. The composite for the enamel layer that was kept at a temperature of 45° C. is filled into the top and bottom mold parts using a syringe. A small round opening in the top part serves as a drain for excess material. The curing process and the removal of the prosthetic tooth correspond to the procedure for the dentin. Lastly, after removing the prosthetic tooth from the mold, the pin is detached from the bottom of the tooth.

### Example D2

To produce the two-layer prosthetic teeth, two-part molds are used that have the contour of the negative mold for the dentin core (bottom part U-I and top part O-I) or after exchanging the mold top O-I with O-II, have the enamel layer and thus the entire prosthetic tooth (bottom part U-I and top part O-II). These negative molds are slightly tapered towards the top, in order to facilitate removal of the tooth prosthesis after polymerization. In contrast to the molds of Example D1, these molds do not have a cavity for the formation of a locking pin. They are shown in FIG. 5; there an embodiment is shown with which a plurality of teeth can be produced. Of course, this molding system variant can also be realized with only one cavity for the production of a tooth or tooth part.

The molding parts are coated with non-stick coating and heated at 45° C. to achieve a better flow behavior of the composite. First, the bottom mold- and top mold of the dentin mold are each with dentin composite, which is also pre-heated to 45° C., using a syringe. Then, the top mold is placed onto the bottom mold part, the mold is closed and the composite cured at 100° C. in the oven for four hours. After the mold is opened, the region of the polymerized dentin core that projects from the mold and onto which the composite for the enamel layer is then coated, and which is at a temperature of 45° C., is sandblasted to achieve mechanical retention. The mold is closed with the second top mold part O-II, which represents the negative mold of the final tooth including enamel region, whereby a small circular opening in the top serves as a drain for excess material. After curing at 100° C. in oven for four hours, the prosthetic tooth is removed from the mold.

### Example D3

To prepare the two-layer denture teeth, a single mold (bottom part U-I) is used in a first step (see FIG. 6), which has the contour of the negative mold of the dentin core. For the subsequent buildup of the enamel layer or of the entire prosthetic tooth, a two-part mold (bottom part U-II and top part O-I) is used. The negative molds are slightly tapered towards the top, in order to facilitate the removal of the dentin core or the prosthetic tooth after polymerization. In addition, the mold sections (U-I and U-II) have a round opening with a diameter of about 3 mm in the center and over the entire height to the bottom part (basal side) of the later tooth, which serves as a locking and catch pin.

The molding parts are coated with non-stick coating and heated at 45° C. to achieve a better flow behavior of the composite. First, the bottom mold of the dentin mold (U-I) is filled with dentin composite, which is also pre-heated to 45° C., using a syringe and thermally cured at 100° C. in an oven for four hours by blue light emitters (e.g., for 100 s) or IR emitters. The infrared emitter (IR emitter) is at a distance of 7 cm from the filled mold. The IR power and the effective duration of the irradiation can be varied. A maximum power is set for the composites to ensure the necessary decomposition temperatures for the respective thermal initiators or to exclude material damage. This can, for example, be 200 watts. The polymerized dentin core is pushed out from below using the locking pin, sandblasted to achieve mechanical retention, and then inserted into the bottom part of U-II, which together with the top part O-II represents the negative mold of the final tooth, including the enamel region. The composite at a temperature of 45° C. for the enamel layer is filled using a syringe into both the top mold and bottom mold and the mold is then closed. A small round opening in the top part serves as a drain for excess material. After curing the composite at 100° C. in the oven for four hours, after opening of the mold the polymerized prosthetic tooth is pushed out from below via the locking pin and the pin detached from the bottom of the tooth.

### E. CURED PROSTHETIC TEETH

### E1

The method for the preparation of prosthetic teeth was performed with the dentin composite C2A-c and the enamel composite C2B-e according to the method D1. The results of the compression tests on the prosthetic teeth constructed from these composites showed that at 3.1 kN they withstand a several-fold larger force than the human bite force of 0.14 to 0.73 kN reported in the literature.

### E2

The method for the preparation of prosthetic teeth was performed with the dentin composite C2A-e and the enamel composite C2B-g according to the method D3 (light-curing for dentin composite+thermal curing for the enamel composites). The results of the compression tests on the prosthetic teeth constructed from these composites showed that at 3.7±0.4 kN they withstand a several-fold larger force than the human bite force of 0.14 to 0.73 kN reported in the literature.

Both methods E1. and E2., together with the high compression until fracture and the flexibility thereby shown, speak for a highly successful production and functionality of the two-layer prosthetic teeth.

What is claimed is:

1. Dental prosthesis comprising a first, inner sub-region which has a first organically polymerized material and a second outer sub-region, which has a second organically polymerized material that is an organically modified and organically polymerized silicic acid (hetero)polycondensate, wherein the first inner sub-region has a flexural strength of over 80 MPa and a lower elastic modulus than the second outer sub-region, while the second outer sub-region has a flexural strength of at least 100 MPa.

2. Dental prosthesis according to claim 1, wherein the first organically polymerized material is polymerized using organically polymerizable groups which are copolymerizable with groups of the second organically polymerized material, and/or where the first organically polymerized material is a first organically modified and organically polymerized silicic acid (hetero)polycondensate.

3. Dental prosthesis according to claim 1, wherein the first, inner sub-region and/or the second outer sub-region each have a flexural strength of at least 130 MPa, where the flexural strength of the second outer sub-region may be greater than that of the first, inner sub-region.

4. Dental prosthesis according to claim 1, wherein the elastic modulus of the first, inner sub-region is at least 5.0 GPa and the elastic modulus of the second outer sub-region is at least 7.5 GPa.

5. Dental prosthesis according to claim 1, wherein the translucency of the first inner sub-region is smaller than the translucency of the second outer sub-region.

6. Dental prosthesis according to claim 1, wherein the organic polymerization of the first, inner sub-region and/or of the second outer sub-region was carried out at least partially via vinyl groups, preferably (meth)acrylic groups, and particularly preferably via methacrylate groups.

7. Dental prosthesis according to claim 1, wherein the first organically polymerized material is a first organically modified and organically polymerized silicic acid (hetero)polycondensate that is modified with phenyl group-containing organic residues and/or where the organically polymerized silicic acid (hetero)polycondensate of the second, outer sub-region is modified with phenyl group-containing organic residues.

8. Dental prosthesis according to claim 1, wherein the organically polymerized silicic acid (hetero)polycondensate of the second, outer sub-region is modified with organic residues having free hydroxy groups.

9. Dental prosthesis according to claim 1, wherein the first, inner sub-region and/or the second outer sub-region consists of a composite that has 15 to 55 wt.-%, preferably 20 to 50 wt.-% of organically polymerized silicic acid (hetero)polycondensate and 45 to 85 wt.-%, preferably 50 to 80 wt.-% of filler, or that has this composite in a proportion of preferably at least 75 wt.-%.

10. Dental prosthesis according to claim 9, wherein the filler consists of glass with an average primary particle size between 0.01 μm and 5 μm, preferably between 0.1 and 3.0 μm.

11. Dental prosthesis according to claim 10, wherein the glass used as filler is silanized.

12. Dental prosthesis according to claim 1, wherein the first inner sub-region is provided with an adhesion promoter on its outer surface and/or has a roughened surface and/or the second outer sub-region is provided with an adhesion promoter on its inner surface.

13. Dental prosthesis according to claim 1, wherein the first inner sub-region has a protrusion that is suitable as locking pin or anchor.

14. Method for manufacturing a dental prosthesis according to claim 1, wherein
(a) an organically polymerizable material as a precursor for the first, inner sub-region of the dental prosthesis is filled into a first negative mold and solidified therein,
(b) the solidified first, inner sub-region in part of a second negative mold, which has a cavity with substantially the shape of the dental prosthesis, is provided with an organically polymerizable silicic acid (hetero)polycondensate as precursor for the second, outer sub-region,
(c) the second negative mold is closed,
(d) the second outer sub-region is solidified by heat curing, and
(e) the dental prosthesis is taken out of the mold.

15. Method according to claim 14, wherein the first negative mold consists of two or more partial sub-regions (U-I/O-I), and is closed after the filling according to step (a), whereupon the first inner sub-region is solidified by heat curing.

16. Method according to claim 14, wherein the first negative mold (UI) remains open after filling according to step (a) and the first, inner sub-region is solidified by exposure to electromagnetic radiation, preferably by light or infrared radiation.

17. Method according to claim 14, wherein the solidified first, inner sub-region of the dental prosthesis is taken out of the first negative mold and transferred to the second negative mold.

18. Method according to claim 14, wherein the solidified first, inner sub-region of the dental prosthesis is left in a sub-region (U-I) of the first negative mold, whereby this part of the first negative mold together with another negative partial mold (O-II) forms the second negative mold.

19. Method according to one of claim 14, wherein the first negative mold has an additional cavity connected to the negative mold for the first, inner sub-region of the dental prosthesis, into which silicic acid (hetero)polycondensate that has not yet organically polymerized is filled in step (a) of the method, such that a locking or gripping pin is formed onto the first, inner sub-region.

20. Method according to claim 14, wherein the first inner sub-region is roughened and/or provided with an adhesion promoter after it has solidified and before it is provided with the second not yet polymerized (hetero)polycondensate.

21. Method according to claim 14, wherein during the solidification according to step (a) the first inner sub-region is not yet fully cured and its complete curing is performed together with step (d).

22. Mold system comprising at least a first and a second negative mold for the production of duromer-curing dental prostheses having an inner region and at least one further sub-region, wherein the inner region and the at least one additional sub-region of the dental prosthesis can be formed of materials with different properties,
wherein the second negative mold (U-II/O-II;U-I/O-II;U-II/O-I;U-I/O-I) is configured such that it forms a second cavity having essentially the shape of the dental prosthesis, wherein
(a) each negative mold consists of at least two parts (U/0), and
(i) the first negative mold (U-I/O-I) is formed such that a first cavity is formed which has a smaller volume than the second cavity, and wherein the geometry of the first cavity is selected such is that the surface of an inner region of the dental prosthesis produced with the first negative mold can be completely or partially coated with an outer layer in the second negative mold or with the at least one additional sub-region of the dental prosthesis so that the finished dental prosthesis or the inner region and the at least one additional sub-region of the dental prosthesis is/can be formed, and/or
(ii) the second negative mold consists of one of the parts of the first negative mold (U-I) and an additional part (O-II),
or
(b) the first negative mold (U-I) is a single part and has an opening for the admission of electromagnetic radiation such as light and the second negative mold consists of the first negative mold (U-I) or a first part of a second negative mold (U-II), each in combination with a second part (O-I), wherein the molds are designed such that together they form a cavity having a geometry that is selected such that the surface of an inner region formed with the first negative mold of the dental prosthesis can be coated completely or partially with an outer layer in the second negative mold so that the finished dental prosthesis is/are formed,
wherein all of the named negative forms have a maximum of one or two openings after being assembled from the perspective parts through which excess resin and/or air can escape.

23. Mold system according to claim 22, characterized in that the mold system comprises at least one additional two-part negative mold with which an intermediate layer between the inner region and the outer layer can be produced.

24. Mold system according to claim 22, characterized in that the first cavity of the first negative mold (U-I) is connected to a second cavity in said first negative mold that enables the formation of a locking or gripping pin to the dental prosthesis.

25. Method for producing a duromer-curing dental prosthesis, in which a mold system according to claim 22 is used and the first negative mold is first filled with at least one first composite that is subsequently cured, and subsequently an inner region of the dental prosthesis thereby formed is introduced into at least one additional mold, which is then filled with the first or a second composite that is subsequently cured, so that the surface of the inner region is completely or at least substantially coated with the first or second composite.

26. Use of a dental prosthesis according to claim 1 as a CAD/CAM block for producing single- or multi-layer crowns, inlays, onlays or veneers, or as prefabricated single or multi-layer crowns, wherein the final finishing of the dental prosthesis is performed via a CAD/CAM process.
